(19) United States
(12) Patent Application Publication
(10) Pub. No.: US 2012/0289312 A1
(43) Pub. Date: Nov. 15, 2012

(54) CONTROLLING A MOTION CAPABLE CHAIR IN A WAGERING GAME SYSTEM BASED ON ENVIRONMENTS AND ECOLOGIES

(76) Inventors: Vernon W. Hamlin, Lisle, IL (US); Edward Brunell, Chicago, IL (US); Faith LeBrun Jennings, Chicago, IL (US); Michael Dicillo, Chicago, IL (US); Eric M. Pryzby, Skokie, IL (US)

(21) Appl. No.: 13/469,170

(22) Filed: May 11, 2012

Related U.S. Application Data
(60) Provisional application No. 61/484,766, filed on May 11, 2011.

(51) Int. Cl. G06F 17/00

(52) U.S. Cl. 463/25

(57) ABSTRACT

Systems and methods described herein include wagering game systems having a motion capable chair that moves in response to events or conditions that originate externally to a wagering game machine associated with the motion capable chair. Example systems and methods to control the motion capable chair include utilization of sensor data or information servers to determine external events or conditions, and using such data to control one or more motion capable chairs. External events or conditions may include notifications, marketing data, progressive game play events, an emotional state of an occupant of a motion capable chair, sounds, or other external stimuli.

### CLAIM OF PRIORITY

This patent application claims the benefit of priority, under 35 U.S.C. Section 119(e), to U.S. Provisional Patent Application Ser. No. 61/484,766, entitled “CONTROLLING A MOTION CAPABLE CHAIR IN A WAGERING GAME SYSTEM BASED ON ENVIRONMENTS AND ECOLOGIES,” filed on May 11, 2011, (Attorney Docket No. 1842.342PRV), which is hereby incorporated by reference herein in its entirety.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to using the environments and ecologies around a wagering gaming system to control motion capable chairs.

### BACKGROUND

Wagering game machines, such as slot machines, video poker machines and the like, have been a cornerstone of the gaming industry for years. Generally, the popularity of such machines with players is dependent on the likelihood (or perceived likelihood) of winning money at the machine and the intrinsic entertainment value of the machine relative to other available gaming options. Players also appreciate the reliability of a gaming machine, as do the casino operators. Gaming operators consequently strive to employ the most entertaining, exciting, and reliable machines available because such machines attract frequent play and hence increase profitability to the operator.

Gaming machine design and innovation has primarily focused on game play, attraction devices, lighting, bonus rounds, payout mechanisms, progressives, and networking. While chairs have been provided as part of some gaming machines, any additional functionality provided by the chair beyond providing a convenient place for the player to sit have been limited to adding audio capability to the chair.

### BRIEF DESCRIPTION OF THE FIGURES

Embodiments discussed in the present document are illustrated, by way of example, and not limitation, in the Figures of the accompanying drawings in which:

FIG. 1 is a perspective view of a wagering game assembly with a motion capable chair in accordance with one embodiment.

FIG. 2 schematically depicts a representation of one example of a wagering game assembly.

FIG. 3 depicts a block diagram of logical components of an example architecture for a wagering game system as described herein.

FIG. 4 depicts a flow chart of an example method for using data representing external events or external conditions to control the operation of a motion capable chair in a wagering game assembly.

FIG. 5 depicts a flow chart of an alternative example method for using data representing external events or external conditions to control the operation of a motion capable chair in a wagering game assembly.

FIG. 6 depicts an example wagering game network.

### DESCRIPTION OF THE EMBODIMENTS

The following detailed description refers to the accompanying drawings that depict various details of examples selected to show how the present invention may be practiced. The discussion addresses various examples of the inventive subject matter at least partially in reference to these drawings, and describes the depicted embodiments in sufficient detail to enable those skilled in the art to practice the invention. Many other embodiments may be utilized for practicing the inventive subject matter other than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” are not intended necessarily to refer to the same embodiment or example; however, neither are such embodiments mutually exclusive, unless so stated or as will be readily apparent to those of ordinary skill in the art having the benefit of this disclosure. Thus, the present invention can include a variety of combinations or integrations of the embodiments and examples described herein, as well as further embodiments and examples as defined within the scope of all claims based on this disclosure, as well as all legal equivalents of such claims.

In general, the embodiments of the invention include systems and methods that cause one or more motion capable chairs associated with wagering game machines to dynamically react to the environment around the motion capable chair. For example, the motion capable chair may, using the systems and methods of the various embodiments, move in response to external events and external conditions. As used herein, an external event or condition is an event or condition that occurs, exists, or is initiated external to the motion capable chair or wagering game machine associated with the motion capable chair. An external event or condition is therefore not a simulation generated by a wagering machine or programmatically initiated by software operating within the gaming machine, but rather is an event or condition that is initiated outside of the gaming machine. Further details regarding various types of external events and external conditions are provided in the discussion below. Generally, events may exist for a short amount of time (e.g., a notification of an email arrival) while a condition may exist for a longer period of time (e.g., stock market levels, blood pressure levels, etc.). External events and external conditions may be referred to collectively as external stimuli.

### Example Wagering Game Assembly

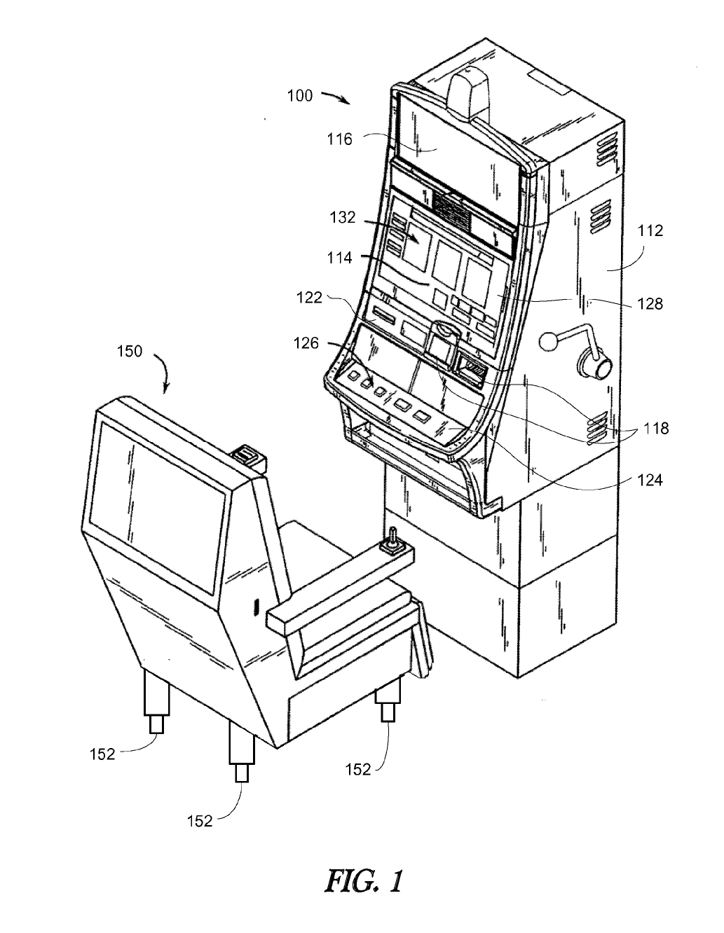

FIG. 1 depicts an example wagering game assembly 100, as one example assembly incorporating novel devices and methods as described herein. According to embodiments, the wagering game assembly 100 can be any type of wagering game machine and can have varying structures and methods of operation. For example, the wagering game assembly 100 can be an electromechanical wagering game machine configured to play mechanical slots, or it can be an electronic wagering game machine configured to present video casino games, such as blackjack, slots, keno, poker, blackjack, roulette, etc.

The wagering game assembly 100 comprises a housing 112 and includes input devices, including value input devices 118 and a player input device 124. For output, the wagering game assembly 100 includes a primary display 114 for displaying information about a basic wagering game. The primary display 114 can also display information about a bonus wagering game or a progressive wagering game. The wagering game assembly 100 also includes a secondary display 116 for displaying wagering game events, wagering game outcomes, or signage information. While some components of the wagering game assembly 100 are described herein, numerous other elements can exist and can be used in any number or combination to create varying forms of the wagering game assembly 100.

The value input devices 118 can take any suitable form and can be located on the front of the housing 112. The value input devices 118 can receive currency or credits inserted by a player. The value input devices 118 can include coin acceptors for receiving coin currency and bill acceptors for receiving paper currency. Furthermore, the value input devices 118 can include ticket readers or barcode scanners for reading information stored on vouchers, cards, or other tangible portable storage devices. The vouchers or cards can authorize access to central accounts, which can transfer money to the wagering game assembly 100.

The player input device 124 comprises a plurality of push buttons on a button panel 126 for operating the wagering game assembly 100. In addition, or alternatively, the player input device 124 can comprise a touch screen 128 mounted over the primary display 114 or secondary display 116.

The various components of the wagering game assembly 100 can be connected directly to, or contained within, the housing 112. Alternatively, some of the wagering game machine's components can be located outside of the housing 112, while being communicatively coupled with the wagering game assembly 100 using any suitable wired or wireless communication technology.

The operation of the basic wagering game can be displayed to the player on the primary display 114. The primary display 114 can also display a bonus game associated with the basic wagering game. The primary display 114 can include a cathode ray tube (CRT), a high resolution liquid crystal display (LCD), a plasma display, light emitting diodes (LEDs), or any other type of display suitable for use in the wagering game machine 100. Alternatively, the primary display 114 can include a number of mechanical reels to display the outcome. In FIG. 1, the wagering game assembly 100 is an “upright” version in which the primary display 114 is oriented vertically relative to the player. Alternatively, the wagering game machine can be a “slant-top” version in which the primary display 114 is slanted at about a thirty-degree angle toward the player of the wagering game assembly 100. In yet another embodiment, the wagering game assembly 100 can exhibit any suitable form factor, such as a free standing model, bartop model, mobile handheld model, or workstation console model.

Wagering game assembly 100 includes a motion capable chair 150. Motion capable chair 150 is located in operational proximity of the housing 112 and includes a plurality of actuators 152. Actuators 152 may be electro-mechanical, pneumatic, hydraulic or any other type of actuator that may be controlled to cause the chair to tilt, rotate, slide laterally left/right, move forward/backward, or otherwise move in various ways. For example, chair position, height, pitch, yaw or roll may be controlled by actuators 152. In addition, actuators 152 may be used to cause the chair to bump, vibrate, or move in any direction.

A player begins playing a basic wagering game by making a wager via the value input device 118. The player can initiate play by using the player input device's buttons or touch screen 128. The basic game can include arranging a plurality of symbols along a payline 132, which indicates one or more outcomes of the basic game. Such outcomes can be randomly selected in response to player input. At least one of the outcomes, which can include any variation or combination of symbols, can trigger a bonus game.

In some embodiments, the wagering game assembly 100 can also include an information reader 122, which can include a card reader, ticket reader, bar code scanner, RFID transceiver, or computer readable storage medium interface. In some embodiments, the information reader 122 can be used to award complimentary services, restore game assets, track player habits and preferences, etc.

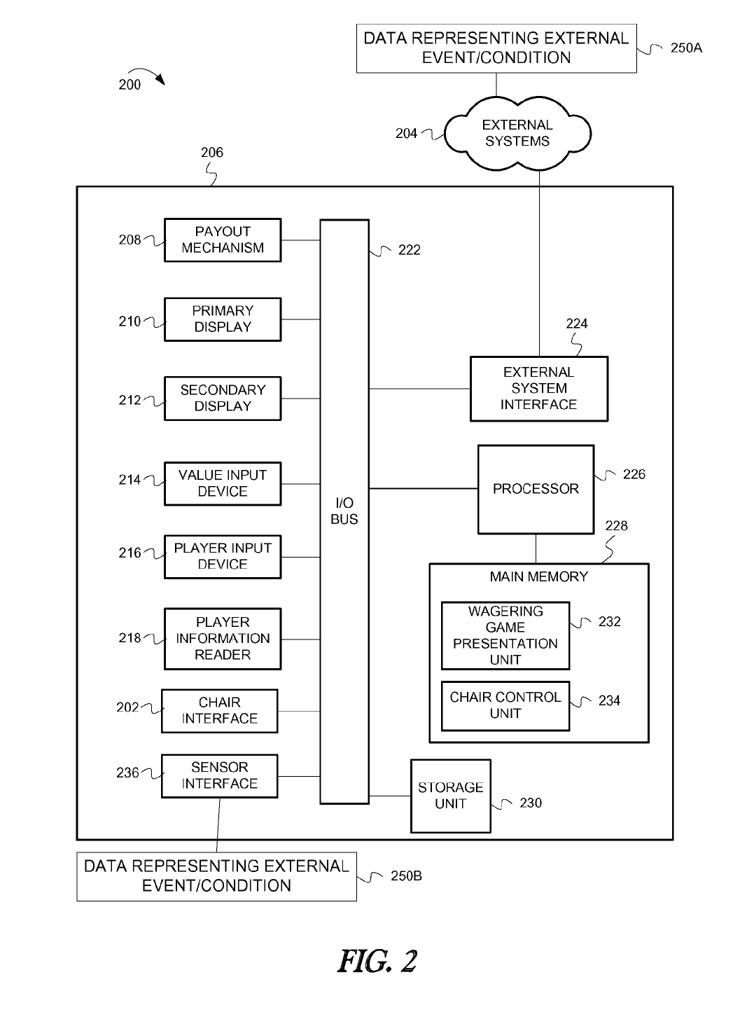

FIG. 2 is a block diagram representation of an architecture 200 of an example wagering game machine 206, including a control system, according to example embodiments of the invention. As shown in FIG. 2, the example wagering game machine 206 includes a processor 226 connected to system main memory 228, and a wagering game presentation unit 232. Wagering game presentation unit 232 can present wagering games at least in part through display functionality associated with the system, such as, for example, the previously described roulette and “virtual” or video poker, blackjack, keno, etc. In this example configuration, the processor 226 is also connected to an input/output (I/O) bus 222, which facilitates communication with and between the wagering game machine's additional components. It should be clearly understood that many wagering game machines will not include all of the described components; and that components need not be connected through a single bus, or through a bus at all. In this illustrative example, the I/O bus 222 is connected to a payout mechanism 208, primary display 210 (which may be either a touch screen display or a conventional display), secondary display 212, a value input device 214, a player input device 216, and a player information reader 218 and other output devices. The I/O bus 222 may also be connected to an external system interface 224, which is connected to external systems 204 (e.g., wagering game networks).

When present, the value input device 214 can include, for example, a reader configured to receive credit from a stored-value card (e.g., casino card, smart card, debit card, credit card, etc.) inserted by a player. The value input device 214 can also comprise a sensor (e.g., an RF sensor) configured to sense a signal (e.g., an RF signal) output by a transmitter (e.g., an RF transmitter) carried by a player. The value input device 214 can also or alternatively include a ticket reader, or barcode scanner, for reading information stored on a credit ticket, a card, or other tangible portable credit or funds storage device. The credit ticket or card can also authorize access to a central account, which can transfer money to the wagering game machine 206. Still other value input devices 214 can make use of touch keys on the touch screen. Upon entry of player identification information and, preferably, secondary authorization information (e.g., a password, PIN number, stored value card number, predefined key sequences, etc.), the player can be permitted to access a player's account. As one potential optional security feature, the wagering game machine 206 can be configured to permit a player to only access an account the player has specifically set up for the wagering game machine 206. Other conventional security features can also be utilized to, for example, prevent unauthorized access to a player's account, to minimize an impact of any unauthorized access to a player's account, or to prevent unauthorized access to any personal information or funds temporarily stored on the wagering game machine 206.

The player input device 216 can include the value input device 214 to the extent the player input device 216 is used to place wagers. Where inputs or wagers are received through the touch screen, as described herein, in many example systems, there may be no need for a separate player input device. In some examples, the wagering game machine 206 will include a player information reader 218 that facilitates identification of a player by reading a card with information indicating the player's identity (e.g., reading a player's credit card, player ID card, smart card, etc.). Such player information reader 218 can alternatively, or also, include a bar code scanner, RFID transceiver or computer readable storage medium interface. In one embodiment, the player information reader 218 comprises a biometric sensing device. Another application of the player information reader 218 may include a reader, such as an RFID interrogator, to read an RFID tag or other RFID device.

In some embodiments, wagering game assembly 100 includes a sensor interface 236. Sensor interface 236 communicably couples one or more sensors to the components of the wagering game assembly 100. The sensors may be any type of sensor including audio (e.g., microphones), video (e.g., cameras), lighting, infrared, pressure, temperature, biometric, motion (e.g., accelerometers) sensors etc. The embodiments are not limited to any particular type of sensor. Further, various embodiments may include one or more sensors in various combinations. The sensors may be located within or near housing 112, or the sensors may be distributed in various locations both within a gaming establishment and outside of a gaming establishment.

In some embodiments, wagering game assembly 100 includes a chair interface 202 that provides an interface between components of wagering game machine 206 and the motion capable chair 150 (FIG. 1). Chair interface 202 comprises hardware, firmware and software used to transfer commands and data between the motion capable chair 150 and components of wagering game machine 206 that may control the chair. For example, in some embodiments a chair control unit 234 executing on the wagering game machine by processor 226 may include instructions indicating that the motion capable chair 150 is to be moved or positioned in a desired manner in response to stimuli originating externally from the wagering game assembly 100, such as external events or external conditions. These instructions translate data 250A/250B representing the external events or external conditions to commands and data that may be sent to the motion capable chair 150 through the chair interface 202 such that the motion capable chair 150 moves in response to the external stimuli. Chair interface 202 may be communicably coupled to the motion capable chair 150 in any of a number of ways, including wired and wireless connections. Although shown in FIG. 2 as directly connected to I/O bus 222, chair interface 202 may be coupled to the bus through an intermediary mechanism such as a USB (Universal Serial Bus) connection.

In some embodiments, a chair control unit 234 is executed by the one or more processors of wagering game assembly 100 and operates to receive data representing external events or external conditions and translates the data to chair motion commands or data which are then sent to the motion capable chair 150.

Although illustrated as resident in memory 228, chair control unit 234 may exist in different forms or in different components than that illustrated in FIG. 2. For example, chair control unit 234 may comprise a hardware or firmware unit that is coupled to the wagering game assembly. Further, in some embodiments, chair control unit 234 may be part of the motion capable chair 150 (FIG. 1). In such embodiments, motion capable chair 150 may include processors, memory, sensors, sensor interfaces, and network interfaces providing the capability for motion capable chair 150 to receive and process data representing external events or external conditions instead of, or in addition to, other units that may receive or process such data. Further details on the operations of a chair control unit 234 in various configurations and embodiments are provided below.

In one embodiment, the wagering game machine 206 can include additional peripheral devices and/or more than one of each component shown in FIG. 2. For example, in some cases, the wagering game machine 206 can include multiple external system interfaces 224 and multiple processors 226. In one embodiment, any of the components can be integrated or subdivided. Additionally, in one embodiment, the components of the wagering game machine 206 can be interconnected according to any suitable interconnection architecture (e.g., directly connected, hypercube, etc.).

In one embodiment, any of the components of the wagering game machine 206 can include hardware, firmware, and/or software for performing the operations described herein. Where functionality is performed at least in part through execution of instructions retained in software and/or firmware, those instructions will be stored (in the machine or in another component) in one or more instances of machine-readable storage media. Machine-readable media includes any mechanism that provides (e.g., stores and/or transmits) information in a form readable by a machine (e.g., a wagering game machine, computer, etc.). Machine-readable media thus includes any media suitable for transmitting software over a network. The above-mentioned “machine readable storage media” is a subset of such machine-readable media, and includes any form of tangible storage media capable of storing data and/or instructions, including, for example, read only memory (ROM), random access memory (RAM), magnetic disk storage media, optical storage media, flash memory devices, etc.

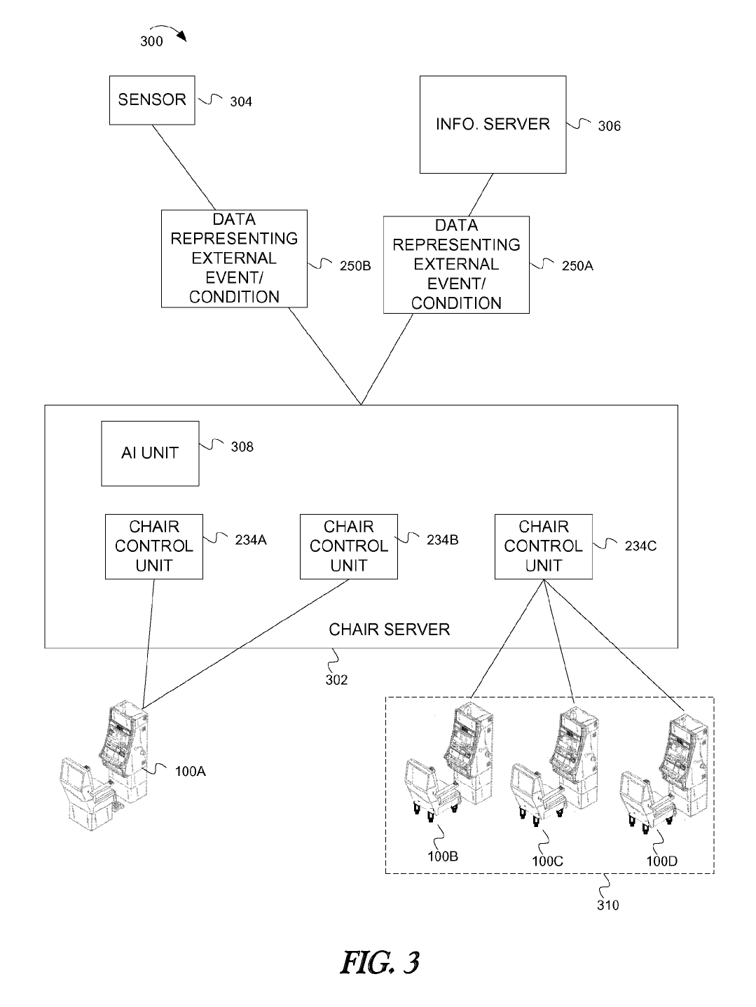

FIG. 3 is a block diagram illustrating the logical components of a system 300 including servers and wagering game machines according to example embodiments of the inventive subject matter. In the embodiments illustrated in FIG. 3, system 300 includes chair server 302, information server 306 and one or more wagering game assemblies 100. In some embodiments, chair server 302 communicates through a wired or wireless network with one or more motion capable chairs associated with wagering game assemblies 100. The communication may be direct to the motion capable chair if the chair is equipped with suitable communications interfaces or the communication may be indirect through a wagering game machine communicably coupled to the motion capable chair.

In some embodiments, chair server 302 communicates data 250 representing an external event or external condition received from a sensor 304 or information server 306 to a wagering game assembly 100. In such embodiments, chair server 302 functions as a relay for the data. The data 250 is then received and processed by the wagering game machine or motion capable chair such that the data representing external events or external conditions is translated to motion commands or data for the motion capable chair.

In alternative embodiments, chair server 302 includes one or more chair control units 234. In such embodiments, the chair control unit 234 on the chair server 302 receives data 250 representing external events or conditions and translates the data to motion commands or data for a motion capable chair. The chair control unit 234 then sends the motion commands or data to the desired motion capable chair.

The relationship between chair control units 234 and motion capable chairs may be one to one, for example from chair control unit 234A to the motion capable chair associated with wagering game assembly 100A. Alternatively, the relationship may be one to many, for example, from chair control unit 234C to a set 310 of motion capable chairs associated with wagering game assemblies 100B, 100C and 100D. Further, the relationship may be many to one, for example from chair control units 234A and 234B to the motion capable chair associated with wagering game assembly 100A.

As illustrated in FIG. 3, the data 250 representing external events or external conditions may come from various sources. In some embodiments, data 250 may originate from sensors 304. As noted above, sensors 304 may be any type of sensor, including audio, video, infrared, pressure, temperature, biometric, or motion sensors and combinations thereof. In alternative embodiments, data 250 may originate from an information server 306. Examples of such servers include email servers, financial servers providing financial data such as stock market data, banking data, exchange rate data etc., news servers, weather servers, sports data servers etc. The embodiments are not limited to any particular type of information server.

In some embodiments, system 300 may include an artificial intelligence (AI) unit 308. AI unit 308 can receive input data from sensors 304 and apply AI heuristics and algorithms to the input to determine chair motion commands and data, or modifications to previously determined motion commands and data to produce desired outcomes. The AI unit 308 thus allows the system to learn desired chair motion commands and data to be produced in response to various external stimuli. Although illustrated as within chair server 302, in alternative embodiments, AI unit 308 may be a component of a chair control unit 234, wagering game assembly 100, or other component of system 300.

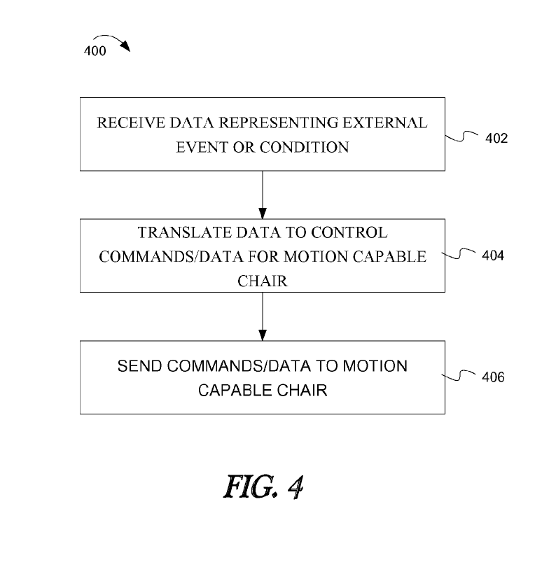

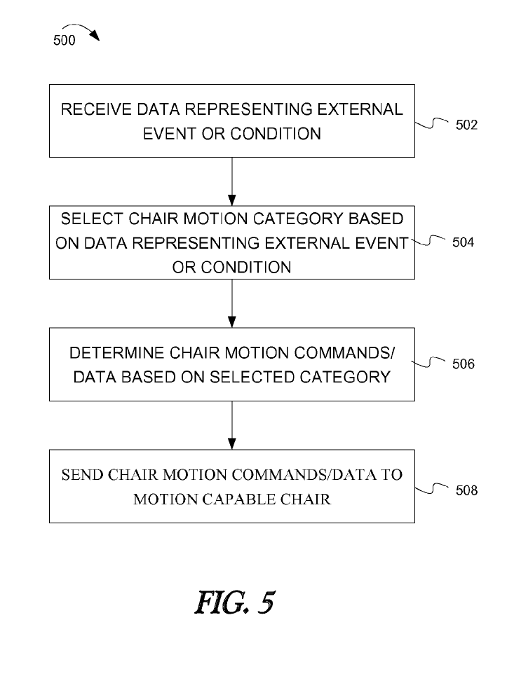

FIGS. 1-3 have provided details on various hardware and software architectures and features of wagering game machine configurations having motion capable chairs. FIGS. 4-5 provide details on various operations performed within these architectures.

### Example Operations for Controlling a Motion Capable Chair

FIG. 4 depicts a flowchart 400 of an example method using data representing external events or external conditions to control the operation of a motion capable chair in a wagering game assembly. The method may be performed at various points in time following the initialization of a wagering game machine, for example during an attract mode or during the presentation of a base wagering game or bonus wagering game. The method begins at block 402 by receiving data representing an external event or external condition. The data may be from one or more sensors, from one or more information servers, or a combination thereof.

At block 404, the data representing an external event or external condition is translated into motion commands or data for a motion capable chair. Numerous translations are possible. In some embodiments, audio data may be translated into chair motion commands or data. In general, chair motion commands or data may control the pitch, roll or yaw of a motion capable chair. Additionally, the chair's height may be raised or lowered, the position of the chair may slide forward, backward, or side-to-side, and the chair may be made to tilt. The motions may be combined to cause the motion capable chair to bump, vibrate, sway or impart a feeling of acceleration, flying motion or driving motion to the occupant of the motion capable chair.

Sensor data or server data may comprise audio data. In some embodiments the system analyzes the audio data to sense a beat or tempo to music played by a wagering game machine or music played in a wagering game establishment. The beat or tempo may be translated into motion commands and data that cause a motion capable chair to move in accordance with the beat or tempo of the music. For example, the chair may sway or bounce to the beat or tempo of the music. Audio data representing the sound of a coin dropping may be translated into commands or data causing a motion capable chair to move in response to the coin dropping. Audio data representing a door opening or closing may be translated to cause the chair to move in response to the door closing or opening. For example, the sound of the door closing or opening may cause the motion capable chair to bump or vibrate to alert the user that someone has entered or left. Audio data representing an audience clapping, cheering, yelling etc. may be translated into chair motion commands and data that cause the chair to rotate or tilt towards the source of the audio event.

Data representing lighting levels may be translated into chair motion commands or data. For example, sensing bright light may be used to cause more dramatic motion of the chair or a wider range of motion for the chair while sensing dimmer light may result in less dramatic motion or a narrower range of motion for the chair.

Data representing visual events or conditions may be translated into chair motion commands or data. For example, visual data may be used for facial recognition. Upon recognizing a face of interest to the user, the chair may be made to move in response to the recognition. Visual data may be used to determine a level of excitement of a player and then translated into chair motion commands or data. For example, visual data may be used to recognize facial expressions indicating that a player or persons around a player are excited or bored. The level of excitement may then be translated into chair motion commands or data that move the chair in accordance with the level of excitement. Other visual indications such as pupil dilation of a player or persons around a player may be used to determine a level of excitement which is then translated into chair motion commands or data. For example, the chair may be made to move more dramatically in order to enhance the excitement for the player.

Similarly, biometric data such as heart rate data, temperature, or blood pressure data can be used to determine a player's level of excitement. The data may be translated into chair motion commands or data that cause the chair to move in accordance with the level of excitement.

Email, social network, or phone data from an email server, social network server or telephone service may be translated into chair motion commands or data. For example, a user's chair may be moved based on the receipt of an email, a friend or colleague logging on to a social network site such as Twitter® or Facebook®, or a message being posted on a social network site. The user's chair may be move in response to receiving a phone call, voice mail or text message.

Stock market data may be translated into chair motion commands in some embodiments. For example, data representing the value of a stock, index or portfolio may be translated into chair motion commands or data such that the chair is made to rise or fall in accordance with the rise or fall in the value of the stock, index or portfolio. Other financial data may be used, for example, the chair may be made to rise or fall in accordance with the value of a bank account balance. Additionally, the motion capable chair may be made to move upon the occurrence of a financial event, such as the value of a stock, index, portfolio or account balance crossing a user defined or predetermined threshold.

Similarly, sports data may be translated into chair motion commands or data. For example, events such as favorite team wins, scoring events, league standings or other sporting related events and conditions may be translated into chair motion commands or data. For example, the chair may be made to bump or vibrate in response to data indicating that a team of interest to the user wins a game, scores points, trades players or performs other sports related activities.

News data and weather data may be translated into chair motion commands or data. For example, the occurrence of significant news events, or events related to particular persons or locations may be translated into chair motion commands or data to alert the user to the events. Weather data may be translated into chair motion or commands such that the chair moves in response to weather events or conditions.

Time-based data may be translated into chair motion commands or data. For example, the motion capable chair may bump or vibrate when an appointment time or a dinner reservation time has arrived, or when a show is about to start. Additionally, the chair may be made to rotate or tilt towards a stage when a show or performance is about to begin on the stage or towards a restaurant when a dinner reservation time has arrived.

Wagering data may be translated into chair motion data or commands. For example, data from a progressive server may be used to cause the chair to move in response to a progressive jackpot win by the player or by another player, or when the progressive is close to hitting. Further, the scale of motion or the range of motion of the chair may be adjusted in accordance with the level of the progressive. For example, a user participating in a progressive having a $1,000,000 jackpot value may have a scale or range of motion that is different from a progressive having a $10,000 jackpot.

Hotel reservation data may be translated into chair motion commands or data. For example, data received indicating that a friend or colleague of the user has checked in may be translated into chair motion commands or data to cause the motion capable chair occupied by the user to move in response to the check-in.

Marketing data may be translated into chair motion data. For example, a motion capable chair may be rotated or tilted towards a display when messages that may be of interest to the chair's occupant are displayed.

External events may originate from other wagering game machines or occupants of other motion capable chairs. For example, an occupant of one motion capable chair may virtually “poke” an occupant of another motion capable chair, where the virtual “poke” causes the other motion capable chair to move, for example as a bump or vibrating motion.

In some embodiments, the data may be filtered. For example, audio data representing game sounds originating from a wagering game machine associated with a motion capable chair may be filtered out or canceled so that the unfiltered audio data remaining may be for sounds or music external to the wagering game machine (e.g., music played within a casino or by another wagering game machine).

Further, the data representing external events or conditions may be prioritized. For example, the chair control unit may prioritize biometric or biofeedback data for a player over visual or audio data. Additionally, the data may be weighted according to source or type of external events or conditions.

User input or preferences may be used to determine the filtering, prioritization, or weighting parameters applied to the data representing external events or conditions. Further, user input may be used to determine triggers for chair movement. For example, a user waiting for a friend to arrive may set a trigger that causes the motion capable chair occupied by the user to move in response to a door opening or closing.

Similarly, user preferences or input may be used to subscribe to particular event data or conditions that are used to cause the motion capable chair to move in accordance with the event or data. For example, a user may subscribe to particular stock market data, sports results data, news data, weather data etc. The data obtained through the subscription may be used to cause the chair to move in accordance with the data.

Preferences can be stored either remotely in a player account database or locally on a memory card carried by the player. If stored remotely, the player can log into the account at an electronic gaming machine by entering login information (e.g., user name and password) or by presenting an account card to the terminal. The account card may be inserted into a card reader or detected wirelessly etc. Further details on communicating player preferences may be found in U.S. Pat. No. 7,147,558, which is incorporated by herein in its entirety.

At block 406 the chair controller sends the chair motion commands or data to a motion capable chair. As discussed above, the chair controller may execute directly on the motion capable chair and the commands and data are thus sent locally within the chair. Alternatively, the chair controller may execute on a wagering game machine associated with the motion capable chair in which case the chair motion commands or data as sent through a chair interface communicably coupling the motion capable chair to the wagering game machine. Further, the chair controller may execute on a server in which case the chair commands or data may be sent through a wired or wireless network to a motion capable chair or to a wagering game machine communicably coupled to the motion capable chair.

Other chair characteristics in addition to, or instead of, chair motion may be controlled in response to external stimuli to augment other senses such as visual or auditory senses. For example, should sensors detect blue light, the lighting on the chair can be made to glow blue in response. As noted above, sound may be filtered by the chair. Alternatively, certain sounds may be enhanced by the chair. Various combinations of motion, visual, and sound effects produced by the chair may be designed to stimulate various emotional responses in a player.

FIG. 5 depicts a flowchart 500 of an example method using data representing external events or external conditions to control the operation of a motion capable chair in a wagering game assembly in accordance with embodiments of the invention. The method may be performed at various points in time following the initialization of a wagering game machine, for example during an attract mode or during the presentation of a base wagering game or bonus wagering game. Similar to method 400 above, the method begins at block 502 by receiving data representing an external event or external condition. The data may be from one or more sensors, from one or more information servers, or combinations thereof. Additionally, the data may be filtered, smoothed, prioritized, or weighted in various ways as discussed above.

At block 504, a chair control unit selects a chair motion category based on the data representing an external event or condition. The chair motion category may be any type of category. For example, in some embodiments, the category may be an emotional state or mood such as happy, sad, excited, angry, bored etc. The emotional state may be that of the occupant of the motion capable chair, that of one or more persons around the occupant or in a gaming establishment, or a generalized emotional state not tied to any particular person or group of persons. In such embodiments, the chair control unit determines an emotional state based on input from one or more sensors, one or more information servers or combinations thereof.

The determination of an emotional state may be based on a variety of data obtained from sensors or information servers. For example, audio data representing cheering or clapping may be used to determine an emotional state. Visual data used for facial expression recognition, pupil dilation evaluation, or motion analysis may be used to determine an emotional state. Biometric or biofeedback data such as body temperature, blood pressure, or pulse rate may be used to determine an emotional state of an occupant or other persons.

Other types of data obtained from sensors or information servers may be used to determine an emotional state. For example, weather data indicating the weather is pleasant (e.g., sunny and warm) may be used to determine a happy emotional state while data indicating the weather is rainy and cold may be used to determine a sad emotional state. Likewise, news data or financial data may be analyzed and used to determine an emotional state.

Other types of categories exist and are within the scope of the inventive subject matter. For example, financial categories such as bull market vs. bear market, performance categories or any other category may be used.

At block 506, the chair control unit determines chair motion commands or data to send to the motion capable chair based on the category. In some embodiments, the chair motion commands or data may be a predetermined set of chair motion commands or data. For example, a file or “playlist” of commands or data may be selected based on the category. As an example, assume that the categories comprise emotional states. If a “happy” emotional state has been determined, a set of commands that cause the motion capable chair to move in a bouncy lilting manner may be selected while if a “sad” emotional state has been determined, then then a of commands may be selected that cause the chair to move in a more subdued manner. In this example, the selected chair motion commands or data complement the determined category. It should be noted that the chair motion commands or data may be selected to counteract the category. For example, if a “bored” emotional state has been determined, then the chair control unit may select a set of commands or data the cause the chair to move in a more dramatic manner to excite the occupant. Conversely, if an “angry” emotional state has been determined, the chair control unit may select a set of commands or data that cause the chair to gently sway or move in a less dramatic manner in order to calm the occupant.

In some embodiments, there may be multiple sets of predetermined chair motion commands or data associated with an individual category. For example, there may be multiple files or playlists associated with a “happy” emotional state and another set of multiple files or playlists associated with a “bored” emotional state. After determining a category, the chair control unit selects one of the multiple sets of chair commands and data for the category. In some embodiments, the selection may be a random selection. In alternative embodiments, the chair control unit may selects in a serial or ordered manner.

In alternative embodiments, the chair motion commands or data determined at block 506 are not predetermined, but instead are dynamically generated based on the selected category. For example, a palette of motion commands or data may exist that may be combined in various ways produce a dynamically generated sequence of chair motion commands or data that correspond with the selected category.

At block 508, the chair controller sends the chair motion commands or data to a motion capable chair. As discussed above, the chair controller may execute directly on the motion capable chair and the commands and data are thus sent locally within the chair. Alternatively, the chair controller may execute on a wagering game machine associated with the motion capable chair in which case the chair motion commands or data as sent through a chair interface communicably coupling the motion capable chair to the wagering game machine. Further, the chair controller may execute on a server in which case the chair commands or data may be sent through a wired or wireless network to a motion capable chair or to a wagering game machine communicably coupled to the motion capable chair.

The example methods 400 and 500 described above have generally been discussed in the context of a single motion capable chair. However, it should be noted that the movement of multiple motion capable chairs (configured as described in FIG. 2) may be coordinated by one or more chair control units. As one example, assume that a chair control unit has determined a sports team followed by a group of friends playing at a bank of wagering game machines has just scored. A chair control unit may cause motion capable chairs associated with the bank of wagering game machines to move as a wave across the chairs.

AI unit 308 may be used to determine chair motion commands or data to provide in response to the various inputs and outputs described above with respect to FIGS. 4 and 5. For example, AI unit 308 may learn to recognize the level of excitement and to also learn chair motion patterns that stimulate excitement in players. Similarly, AI unit 308 may learn to recognize external stimuli that indicate how long the user will continue to play the game. AI unit 308 may also learn chair motion command and data that will stimulate the user to play longer. For example, AI unit 308 may learn that a person will stay in the chair and play longer if the chair motion is softened and if unpleasant sounds are blocked. AI unit 308 can learn patterns of external stimuli and responsive chair motion commands and data that apply to a particular user, particular group of users, or generally applicable to all users.

### Example Wagering Game Network

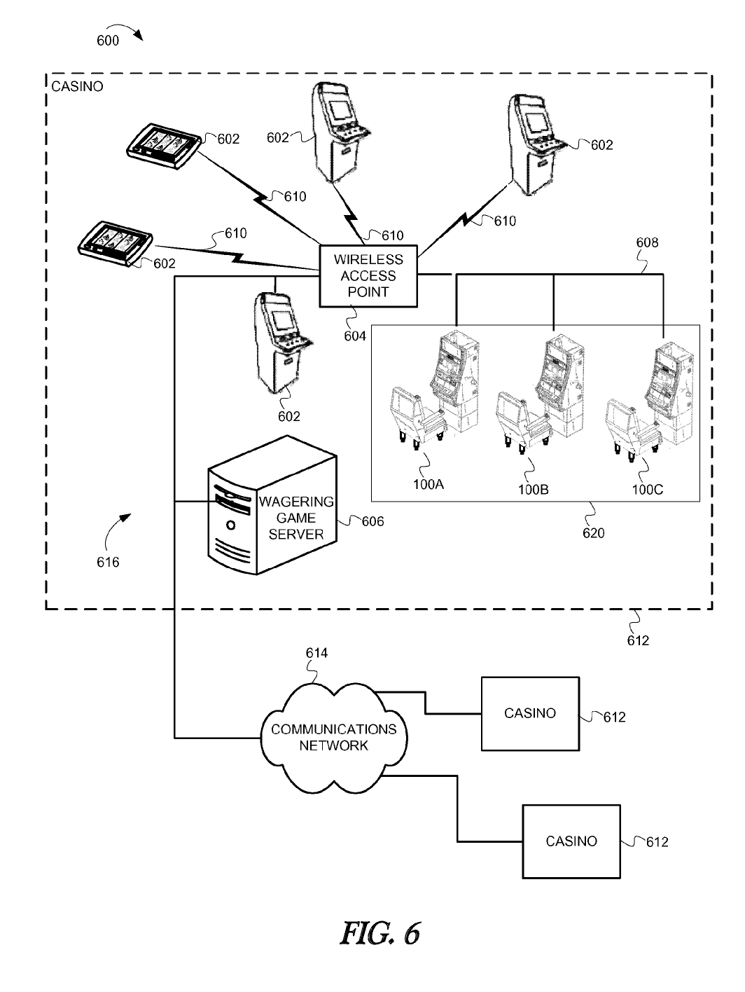

While the previous discussion has illustrated operations with a perspective a single wagering game machine, FIG. 6 shows how a plurality of wagering game machines can be connected in a wagering game network 600, according to example embodiments of the invention. As shown in FIG. 6, the example wagering game network 600 includes not only a plurality of wagering game machines and banks of wagering games that may exist within a casino, but may also include multiple casinos 612 connected to a communications network 614.

Each of the plurality of casinos 612 includes a local area network 616, which may include a wireless access point 604, wagering game machines 602, and in an example, a wagering game server 606 that can serve wagering games over the local area network 616. As such, the local area network 616 includes wireless communication links 610 and wired communication links 608. The wired and wireless communication links can employ any suitable connection technology, such as serial communications lines, Bluetooth, 802.11, Ethernet, public switched telephone networks, SONET, etc.

Wagering game machines can be organized as a bank of machines 620, where the bank of machines may be linked through network 616, or through a network or other communications system that is local to the bank of machines 620. In some embodiments, bank of machines 620 may be comprised of wagering game machines that are the same type or have the same general theme. The bank of machines 620 may share an overhead sign or kiosk. In the example provided in FIG. 6, three wagering game machines 100A-C with motion capable chairs are shown. Those of skill in the art will appreciate that a bank may have two wagering game machines or more than three wagering game machines.

In one embodiment, the wagering game server 606 can serve wagering games and/or distribute content to devices located in other casinos 612 or at other locations on the communications network 614.

The wagering game machines 602 and wagering game server 606 can include hardware and machine-readable media including instructions for performing the operations described herein.

The wagering game machines 602 described herein can take any suitable form, such as floor standing models, handheld mobile units, bartop models, workstation-type console models, etc. Further, the wagering game machines 602 can be primarily dedicated for use in conducting wagering games, or can include non-dedicated devices, such as mobile phones, personal digital assistants, personal computers, etc. In one embodiment, the wagering game network 600 can include other network devices, such as accounting servers, wide area progressive servers, player tracking servers, and/or other devices suitable for use in connection with embodiments of the invention.

In various embodiments, wagering game machines 602 and wagering game servers 606 work together such that a wagering game machine 602 may be operated as a thin, thick, or intermediate client. For example, one or more elements of game play may be controlled by the wagering game machine 602 (client) or the wagering game server 606 (server). Game play elements may include executable game code, lookup tables, configuration files, game outcome, audio or visual representations of the game, game assets, or the like. In a thin-client example, the wagering game server 606 may perform functions such as determining game outcome or managing assets, while the wagering game machine 602 may be used merely to present the graphical representation of such outcome or asset modification to the user (e.g., player). In a thick-client example, game outcome may be determined and presented locally (e.g., at the wagering game machine 602) and then communicated to the wagering game server 606 for recording or managing a player's account.

Similarly, functionality not directly related to game play may be controlled by the wagering game machine 602 (client) or the wagering game server 606 (server) in embodiments. For example, power conservation controls that manage a display screen's light intensity may be managed centrally (e.g., by the wagering game server 606) or locally (e.g., by the wagering game machine 602). Other functionality not directly related to game play may include presentation of advertising, software or firmware updates, system quality, or security checks, etc.

### General

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. For example, while the embodiments discussed above have been in the context of a wagering game system, the chair and chair controller could be part of a non-wagering game system such as a video game system. Further, the chair may be a standalone chair and need not be integrated with, our coupled to, a wagering or non-wagering game system.

Additionally, although embodiments described above have been discussed in the context of a motion capable chair for a wagering game system, other objects may be used in addition to, or instead of, a chair. Controlling a chair is one method to impart physical actions and to stimulate perceptions/actions on another object (a user). The physical actions produced in response to external stimuli can be for all senses (motion, sight, smell, touch, etc., and complex perceptions resulting from those perceptions, including emotional perceptions) and may cause simulated perceptions/actions as perceived by an animate or inanimate object. Further, the actions of one object may be external stimuli received by other objects, which in turn act on the stimuli. For example, the motion of one chair in response to a first external stimulus may be stimuli for a second motion capable chair.

Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

Each of the embodiments described herein are contemplated as falling within the inventive subject matter, which is set forth in the following claims.

What is claimed is:

1. A wagering game system comprising:
a gaming machine including one or more processors configured to present a wagering game upon which monetary value may be wagered;
a motion capable chair communicably coupled to the gaming machine; and
a chair control unit configured to:
receive data representing an external event or external condition, and
translate the data representing the external event or external condition into control commands or data for causing the motion capable chair to move in response to the data representing the external event or external condition.

2. The wagering game system of claim 1, comprising one or more sensors, wherein the one or more sensors provide signals included in the data representing the external event or external condition.

3. The wagering game system of claim 1, comprising a network interface to receive the data representing the external event or external condition.

4. The wagering game system of claim 3, comprising an information server configured to send the data representing the external event or external condition to the network interface.

5. The wagering game system of claim 1, wherein the external event includes a time-based event.

6. The wagering game system of claim 5, wherein the time-based event includes one or more of an appointment time, a reservation time, or a show time.

7. The wagering game system of claim 1, wherein the external event includes an audio event.

8. The wagering game system of claim 7, wherein the audio event includes one or more of a coin drop, a cheer, a clap, a door opening or a door closing.

9. The wagering game system of claim 1, wherein the external condition includes one or more of a stock market level, a bank account balance, a sports result, or weather conditions.

10. The wagering game system of claim 1, comprising a display configured to present marketing data, wherein the motion capable chair is moved to face the display in response to data representing an external event or external condition that includes marketing data.

11. A method comprising:
presenting, via a wagering game machine, a wagering game upon which monetary value may be wagered;
receiving data representing an external event or external condition; and
translating, utilizing one or more processors, the data representing the external event or external condition into control commands or data for causing a motion capable chair, communicably coupled to the wagering game machine, to move in response to the data representing the external event or external condition.

12. The method of claim 11, comprising filtering, weighting or prioritizing the data representing the external event or external condition.

13. The method of claim 12, wherein filtering, weighting or prioritizing the data includes filtering, weighting or prioritizing the data in accordance with one or more user preferences or interests.

14. The method of claim 11, wherein the chair motion commands or data control at least one of a pitch, roll or yaw of the motion capable chair.

15. The method of claim 11, wherein the chair motion commands or data cause the motion capable chair to move to simulate acceleration.

16. The method of claim 11, wherein the chair motion commands or data cause the motion capable chair to rise, lower, tilt, bump or vibrate.

17. The method of claim 11, comprising:
presenting marketing data on a display coupled to the wagering game machine; and
moving the motion capable chair to face the display in response to data representing an external event or external condition that includes the marketing data.

18. A method of claim 11, comprising: utilizing a chair motion category in determining chair motion control commands or data to send to the motion capable chair;
wherein the data representing the external event or external condition include selecting the chair motion category.

19. The method of claim 18, wherein the chair motion category comprises an emotional state of an occupant of the motion capable chair.

20. The method of claim 18, comprising coordinating movement of the motion capable chair with movement of at least one other motion capable chair in response to the selected chair motion category.

21. A machine-readable medium having executable instructions stored thereon, that when executed, cause one or more processors to perform operations comprising:
presenting, via a wagering game machine, a wagering game upon which monetary value may be wagered;
receiving data representing an external event or external condition; and
translating the data representing the external event or external condition into control commands or data for causing a motion capable chair, communicably coupled to the wagering game machine, to move in response to the data representing the external event or external condition.

22. The machine-readable medium of claim 21, wherein the external event or condition comprises a level of a progressive jackpot, and wherein the motion capable chair is moved in response to the level of the progressive jackpot.

23. The machine-readable medium of claim of claim 22, wherein the external event or condition comprises marketing data presented on a display, and wherein the motion capable chair is moved to face the display in response to the marketing data being of interest to an occupant of the motion capable chair.

24. The machine-readable medium of claim of claim 21, wherein the external event comprises a notification event.
